(19) United States
(12) Patent Application Publication
(10) Pub. No.: US 2007/0286267 A1
(43) Pub. Date: Dec. 13, 2007

(54) RF power sensor

(76) Inventors: Jonathan Brereton Scott, Santa Rosa, CA (US); Eric Breakenridge, Alloa (GB)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/450,216

(22) Filed: Jun. 8, 2006

(51) Int. Cl. H04B 17/00

(52) U.S. Cl. 375/224

(57) ABSTRACT

A power meter having a sample and hold circuit, a trigger signal generator, and a data processor is disclosed. The sample and hold circuit receives an input signal, V(t), and generates a measurement of that signal at a time determined by a trigger signal that is generated by the trigger signal generator. The trigger signal generator generates a plurality of trigger signals over a sampling time period thereby causing the sample and hold circuit to generate the measurements at a plurality of non-evenly spaced times during the sampling time period. The data processor processes the received measurements to provide a measurement of a desired signal property such as mean power or peak power to within a predetermined error.

### BACKGROUND OF THE INVENTION

Power meters that measure the average and peak power from an RF transmitter are often used to assure compliance with government regulations governing the operation of such transmitters. These RF transmissions typically involve the modulation of a carrier. To provide such measurements, the power meter must measure the peak power at the maximum modulation frequency.

Prior art power measuring instruments typically utilize one of two designs. The power meter is designed to plug into the transmitter in place of the antennae. As such the power meter must present an impedance equal to that of the antennae, which is typically 50 ohms. In the first type of power meter, the signal is applied across a 50-ohm resistor and the temperature of the resistor is sensed to determine the power being dissipated in the resistor. This type of power meter is very accurate, since it measures the power delivered into the load. However, the ability of the power meter to track the power fluctuations at the modulation frequency is limited to modulation frequencies of less than a few kilohertz.

The second type of power meter also applies the signal across a resistor having an impedance equal to that of the antenna. The voltage across the resistor is rectified in a circuit having two diodes and a set of capacitors that generates a signal related to the power. The rectification removes the underlying carrier frequency but allows the output voltage to track the power in the modulation signal. This type of power meter has less accuracy than the power meters discussed above; however, the upper limit on the modulation frequency is significantly higher. This type of power meter can be used to measure the peak power at the modulation frequency for modulation frequencies up to a few megahertz.

Recent cellular telephone standards have substantially higher modulation frequencies, and hence, are out of the range of the first type of power sensor discussed above. The current CDMA standards involve carriers that are modulated at frequencies up to 5 MHz, and hence, the transmitters can only just be monitored using the power meters discussed above. However, proposed standards involve modulation frequencies of more than 500 MHz. Accordingly, some new form of power measurement system is needed to test transmitters in the field for compliance with the relevant regulations.

### SUMMARY OF THE INVENTION

The present invention includes a power meter having a sample and hold circuit, a trigger signal generator, and a data processor. The sample and hold circuit receives an input signal, V(t), and generates a measurement of that signal at a time determined by a trigger signal that is generated by the trigger signal generator. The trigger signal generator generates a plurality of the trigger signals over a sampling time period thereby causing the sample and hold circuit to generate the measurements at a plurality of times during the sampling time period. The data processor receives the generated measurements and processes the received measurements to provide a mean power measurement for the input signal during the sampling time period. The trigger signals are generated at a sequence of times that are not uniformly spaced and chosen such that a plurality of measurements has the same value of a desired signal property, such as mean power or peak power, as the input signal. In one aspect of the invention, the sampling times are chosen randomly within the sampling time period. In another aspect of the invention, the data processor forms a statistical distribution of the received measurements to provide the measurement of other signal properties such as the peak power generated by the input signal into a predetermined load during the sampling time period.

### BRIEF DESCRIPTION OF THE DRAWINGS

FIG. 1 is a block diagram of a power meter according to one embodiment of the present invention.

### DETAILED DESCRIPTION OF THE PREFERRED EMBODIMENTS OF THE INVENTION

Consider a signal V(t) that is applied across a resistor R. The power dissipated in the resistor at time, t, is P(t)=V²(t)/R. If one could measure V(t) accurately over a time interval from t₁ to t₂, the average power dissipated over this time period could be computed by integrating P(t) between t₁ and t₂. If V(t) is a modulated carrier in the GHz range, this approach requires making measurements of V(t) at time points that are separated by times of the order of a picosecond. Instruments that can provide such fine measurements for an arbitrary modulation of the carrier are complex and expensive.

In addition, the number of points that must be included in the integral can be very large if the lowest modulation frequency is much less than the carrier frequency. To provide an average power by integrating the signal over a time period of interest, the time period needs to be long compared to the period of the lowest modulation frequency of interest. Consider the case of a 10 GHz carrier that is modulated at 100 MHz. To provide an accurate integration, the sample points must be taken at intervals that are less than half the period of the carrier. In addition, the integration needs to be carried out on a time scale that is large compared to the period of the modulation waveform or exactly equal to it. For example, if the time periods are set to one tenth the carrier period and samples are taken for 10 modulation periods, 10,000 samples must be taken and processed. The time to acquire this quantity of data and process the data can excessive, especially for modulations where the lowest modulation frequency is only a few kilohertz.

In principle, a sampling oscilloscope and a suitable data processor could be used to provide the desired closely spaced measurements if the signal in question were periodic. A sampling oscilloscope can be viewed as a sample and hold circuit that makes measurements of the input signal at a series of very precisely controlled time points. The time over which the input signal is sampled is short compared to the rate of change of the input signal, and hence, an individual measurement represents the instantaneous potential of the input signal even for signals in the 50 GHz range.

Unfortunately, the time between successive samples must be much larger than the period of the highest frequency in the signal. To overcome this problem, a sampling oscilloscope makes use of the periodic nature of the input signal. In essence, the sampling oscilloscope takes samples at a set of precisely timed points that sample the input signal during different periods of the periodic input signal at a set of times that allow the sampling oscilloscope to reconstruct the signal.

The present invention is based on three observations. First, measurements of the average power and peak power in a signal, V(t), do not require a detailed knowledge of the signal function V(t). As will be explained in more detail below, these quantities can be derived from a set of signal samples, V(tᵢ), in which the precise sampling times, tᵢ, do not need to be known.

Second, the high cost of a sampling oscilloscope lies in the circuitry for defining the precise set of measurement times, not in the sampling and hold circuitry that makes the individual measurements. Hence, if a precise knowledge of the sampling times is not needed, a relatively inexpensive measurement instrument can be constructed based on the sample and hold circuitry developed for sampling oscilloscopes.

Third, the number of samples needed to determine the mean and peak power in the signal is much less than that needed to generate an accurate integration of the power function over the desired sampling interval. If enough samples are taken at representative points in the time interval of interest, the quantities of interest can be determined by observing the statistical distribution of the power measurements made at the points in question. The number of samples needed is determined by the statistical distribution and the required accuracy, as opposed to the number of points needed to compute the integral discussed above.

The present invention is based on sampling the RF signal at a set of time points chosen such that the resulting voltage measurements can be processed statistically to determine the average and peak power from the transmitter over the period in which the samples were taken. Each measurement represents the average amplitude in the signal over a time period that is small compared to the period of the carrier signal. It is assumed that the average power and peak power are constant over the time period in which the measurements are accumulated.

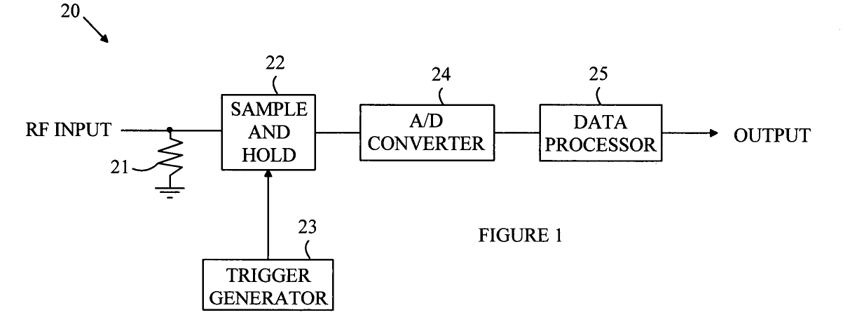

Refer now to FIG. 1, which is a block diagram of a power meter according to one embodiment of the present invention. The RF signal to be measured is connected across a resistor 21 that matches the impedance of the RF transmission system. A sample and hold circuit 22 samples the RF input signal at times specified by trigger signal generator 23. Each sample represents the average of the RF input signal over a time period that is small compared to 1/f, where f is the frequency of the RF carrier. The sampling time, i.e., the time the sample and hold circuit samples the signal to provide a single measurement, is preferably less than one-tenth of 1/f, where f is the highest frequency of interest in the input signal. In the case of a modulated carrier, f is the frequency of the carrier. Sample and hold circuits having a sampling time of less than 5 picoseconds are available on sampling oscilloscopes. For the high frequencies power meters designed to measure compliance with the cellular standards discussed above, the sampling times are preferably less than 10 picoseconds. However, meters having other sampling times can also be constructed.

As noted above, sample and hold circuits capable of providing such fast sampling are well known in the sampling oscilloscope arts, and hence, will not be discussed in detail here. Reviews of the techniques for performing such sampling can be found in W. M. Grove, “Sampling for oscilloscopes and other RF systems: DC through X-band”, IEEE Trans. on Microwave Theory and Tech., December 1966, vol. MTT-14, No. 12, and G. Frye, “A new approach to fast gate design”, Tektronix Service Scope, October 1968, No. 52. As noted above, such sample and hold circuits are relatively inexpensive. The high cost of a sampling oscilloscope is the result of the circuitry needed to provide the trigger pulse to the sample and hold circuit. In a sampling oscilloscope, the trigger pulse timing must be accurate to a fraction of the period of the highest frequency that the oscilloscope is designed to measure.

Sample and hold circuit 22 is triggered by trigger signal generator 23. The manner in which the trigger intervals are selected will be discussed in detail below. For the purpose of the present discussion, it is sufficient to note that trigger signal generator 23 is operated such that the samples collected by sample and hold circuit 22 provide an unbiased sample of the waveform input to power meter 20. While the sampling window needs to be quite short in time, the rate at which samples are taken is not critical. In general, each sample is processed by an analog-to-digital converter (ADC) 24. The minimum time between samples is determined by the cycle time of this converter.

The result of each measurement is transferred to a data processor 25 that performs a statistical analysis on the set of the measurement to provide a measurement of the average power and peak power during the period in which the samples were taken. The square of the voltage, V, across resistor 21 at any given time is proportional to the power in the input signal at that point in time. The average power in the signal over the time period in which samples are taken can be computed from the square of the signal from the sample and hold circuit. In many applications, the quantity of interest is the average power, which is obtained by averaging the square of the voltage, i.e., V², and then computing the square root of the result.

In principle, the instantaneous peak power during the time period is the maximum value observed for the value of V². Unfortunately, this quantity is sensitive to the level of noise in the system. Instrument noise tends to be averaged out in the case of the mean power measurement, since this quantity depends on the average of a large number of individual measurements. However, the peak power measurement does not have this noise reduction property. In addition, merely using the power in the highest power sample measured assumes that the sampling times were chosen such that the peak power occurred at one of the sampling times. In general, this condition may not be satisfied; although, if the number of sampling points is sufficiently large, the peak power could be obtained with good certainty by this algorithm.

In one embodiment of the present invention, data processor 25 constructs a statistical distribution of the power measurements that is used to determine the peak power. In general, the shape of that distribution is determined by the type of signal being measured. If the form of the distribution is known, then the peak and mean power values can be obtained by fitting the known distribution shape to the observed distribution.

In one implementation, data processor 25 can store a number of exemplary distribution shapes. Each of these shapes can be fit to the observed statistical distribution. If one of the stored distributions fits the data to within a predetermined error measure, then the fitted values for the mean and peak power associated with that distribution are utilized.

In some cases, methods based on fitting the entire observed data set to a predetermined distribution shape are not practical. For example, the details of the statistical distribution are not known or the stored distributions do not fit the observed data. In addition, embodiments in which data processor 25 lacks the computational capacity to perform the data fitting algorithms needed to fit the entire distribution to the observed data may be constructed to reduce costs. In these cases, a fit to the high power portion of the observed distribution can be used to provide a peak power measurement and the appropriate average of the individual power measurements can be used to provide the average power measurement of interest. For the purposes of the present discussion, the peak power is defined to be the power at which the statistical distribution of power measurements goes to zero on the high end of the statistical distribution. This point can be approximated without detailed knowledge of the form of the overall statistical distribution. For example, the observed high power portion of the distribution can be fitted to a low order polynomial to estimate the power at which the observed statistical distribution goes to zero. This method also has the advantage of averaging a number of high power measurements in a manner that reduces the effects of noise in the individual measurements.

While the above-described embodiments utilize a particular definition for the “peak power”, devices based on other definitions of “peak power” can also be constructed utilizing the teachings of the present invention. For example, the peak power can be defined to be a point on the statistical distribution at which some predetermined fraction of the samples have power values that are less than that point. Such definitions are useful in cases in which the statistical distribution decreases asymptotically to zero over a wide range of power readings, and hence, is poorly defined.

The number of samples that must be taken is determined by the number needed to determine the statistical distribution, or the high power portion thereof, to the desired accuracy. In general, this will be the number of samples needed to determine the high power portion of the distribution with sufficient accuracy to provide the desired estimate of the peak power in the signal. This number may be determined a priori for a given class of signals, where the unknown signal is known to belong to a class or to adhere to a known standard. Otherwise it may be determined from an ongoing analysis of the evolving result, completion being deemed when a given stability is achieved, i.e., when the result ceases to change significantly with increasing sample set.

As noted above, trigger signal generator 23 must sample the input signal in a manner that does not bias the statistical measurements. The manner in which this constraint is satisfied can be more easily understood with reference to the process by which the sampling system transforms the input signal. The sample and hold circuit together with the trigger signal generator can be viewed as a circuit that transforms the input signal to an output signal consisting of a sequence of digital values. The data processing system then measures the power in the output signal to obtain an estimate of the average power and peak power in the input signal over the time period in which the samples are taken. Hence, the average power and peak power in the output signal must be equal to the average power and peak power, respectively, in the input signal to within some predetermined margin of error for the system to function as a power meter with the desired accuracy. The properties of the transformation are determined by the pattern of trigger signals.

One method for realizing this goal is to choose a trigger signal pattern that assures that all of the energy in the input signal within the frequencies of interest is mapped into the output signal by the transformation. This constraint can be more easily understood in the frequency domain. The Fourier transform of the input signal represents the amplitude of the input signal over the sampling time in at each frequency. The energy in each frequency is proportional to the square of this amplitude. Similarly, the Fourier transform of the output signal represents the amplitude of the output signal at each frequency, and the energy at each frequency can be obtained by computing the square of that amplitude. A transformation satisfying the above constraint will be obtained if all of the energy at each frequency in the input signal is mapped by the transformation to the frequencies contained in the output signal. It should be noted that the mapping will, in general, not be one-to-one. That is, the energy in one of the frequencies in the input signal will appear in more than one of the frequencies in the output signal.

It can be shown that the above criteria are satisfied if the series of time sample points have a “white” distribution. For the purposes of this discussion, the trigger signal time points are said to have a white distribution to within some predetermined error if the Fourier transform of the sequence of time points is constant as a function of frequency within that error. Since the number of time points in the output function, and hence, the sampling sequence, is finite, the condition that the sequence have a white distribution can only be approximately met. That is, the Fourier transform of the time point sequence will be constant to within some margin or error that depends on the number of points in the sequence.

One method for providing a white time point distribution is to utilize a trigger signal generator in which the times between samples are chosen randomly between two time limits so that every point on the input signal within the time period in which the measurements are made has an equal probability of being sampled. Circuits for providing a random delay between each pair of trigger signals are known to the art, and hence, will not be discussed in detail here. For example, circuits that generate a pseudo-random sequence of values between two values from a starting “seed” are often used in the computer arts. While such pseudo-random sequences are not perfectly “white”, they are white to within some predetermined error, and hence, can provide a result that is accurate to a level that is adequate for many applications. In addition, circuits that utilize a radioactive source that irradiates a detector are also used to provide a sequence of pulses having a random distribution. Similarly, circuits that utilize white noise generated from a resistor through which a current flows are also known to the art.

It should be noted that a sampling time sequence in which the time points are taken at uniformly spaced intervals will fail to satisfy the above conditions for at least one frequency. Consider the simple case in which the input signal is a pure sine wave having an amplitude A, i.e., A sin(2πwt). In the systems of interest, w is in the GHz range. For the purpose of this example, assume w=1 GHz. The trigger signal generator is limited to the frequencies at which the A/D converter 24 can process data. These frequencies are typically in the MHz range. For the sake of this example, assume that one sample per microsecond is processed. Suppose the trigger circuit generated samples at regular intervals in which t=I*m/w, where m/w is greater than or equal to 1 microsecond, and m and I are integers. That is, m is of the order of 10³. The I^{th} sample would have a value A sin(2π*I*m)=0, independent of the value of I. That is, the data processor would compute an average power of zero and peak power of zero. These results are clearly in error. The error in this example arose because the transformation of the input signal to the sampled values did not map the energy of the signal at w into the sampled values. That is, the total energy in the sampled values was less than the energy in the input signal.

It should be noted that the while the sample and hold arrangement of the present invention is similar to that used in a conventional sampling oscilloscope, conventional sampling oscilloscopes do not operate in the same manner. First, a conventional sampling oscilloscope samples the input signal at a set of times that have a constant spacing, namely I*(T+t) for I=0,1,2, . . . . Here T is a multiple of the period of the repeating input signal and t is a fixed value that is small compared to T. As noted above, a sampling scheme that utilizes evenly spaced time points does not provide the required transformation, since it can fail to map the energy in one frequency to the output signal. Furthermore, as noted above, sampling oscilloscopes are designed to generate an output signal that is identical to the periodic input signal but mapped to a low frequency; hence, they do not materially transform the input signal.

It should be noted that on the time scales of interest here, conventional timing circuits can include sufficient noise to provide a sufficiently randomized time point set. A conventional timing circuit based on a free-running oscillator of some form can have an uncertainty of its trigger points of several nanoseconds. Hence, the time points defined by such a circuit will be spread around the nominal period of the oscillator by an amount that assures that a signal with a carrier frequency in the GHz range is sampled randomly over the period of the underlying carrier. If the oscillator period is not related to the modulation frequencies of interest by a rational number, then the sampling set may be sufficiently representative of the signal to provide the unbiased sampling required to produce a mean and maximum power measurement within the desired accuracy.

The appropriateness of any particular sampling strategy that is not known to be random can be tested, in principle. For example, in instruments that store a number of expected distributions, the observed distribution can be tested against the expected distributions. If the observed distribution matches one of the stored distributions within a predetermined accuracy, then the user has some assurance that the sampling system is adequate even though it is not a “random” sampling system.

In another example, a number of different sampling protocols are used to generate data. If several distribution shapes are stored and each protocol generates data of the same shape and also generates values for the average and peak powers that are consistent with one another, the user can have more confidence in the measured power values. Similarly, in systems that utilize some form of regular sampling interval such as a free-running oscillator with noise in the trigger points, testing several different oscillator frequencies for consistent results can be used to provide confidence in the measured power values. It should be noted that the different frequencies should not be related to one another by a rational multiplier to assure that two different frequencies do not provide data that is correlated with a particular modulation frequency in the signal.

The above embodiments of the present invention provide measurements of the average and peak power in the input signal to within some predetermined accuracy. In general, the desired accuracy is determined by the specific application in which the power meter is utilized. For example, power meters for use in testing RF transmission systems for compliance with U.S. government regulations typically require an accuracy of a few percent. However, instruments that offer reduced accuracy in exchange for faster delivery of result data are possible. Embodiments in which the accuracy of the power measurements the error is less than 5 percent can be constructed.

The embodiments described above have been directed to measuring the average and peak power in the input signal. However, embodiments that provide measurements of other parameters can also be constructed. As noted above, the present invention operates by transforming the input signal into an output signal that is more easily analyzed to determine the desired property than the original input signal. The timing of the sampling points determines the nature of this transformation. If the timing sequence is chosen such that the transformed signal has the same value of the desired property as the input signal to within the desired accuracy, then an embodiment of the present invention for measuring the desired property can be constructed. It should be noted in this regard that a white timing sequence as discussed above provides a transformation that preserves many other signal properties, and hence, is particularly useful in designing a more general purpose instrument in which the user can program the data processor with the desired statistical analysis to be performed on the signal samples. For example, a measure of a signal's cumulative distribution function (CDF) is useful in some applications.

Various modifications to the present invention will become apparent to those skilled in the art from the foregoing description and accompanying drawings. Accordingly, the present invention is to be limited solely by the scope of the following claims.

What is claimed is:

1. An apparatus comprising:
a sample and hold circuit that receives an input signal, V(t), and generates a measurement of that signal at a time determined by a trigger signal;
a trigger signal generator that generates a plurality of said trigger signals over a sampling time period thereby causing said sample and hold circuit to generate said measurements at a plurality of times during said sampling time period, said plurality of times being spaced at non-constant intervals; and
a data processor that processes said received measurements to provide a measurement of an input signal property,

2. The apparatus of claim 1 wherein said input signal property is an estimate of the mean power in said input signal.

3. The apparatus of claim 1 wherein in said input signal property is an estimate of the peak power in said input signal.

4. The apparatus of claim 1 wherein said measurement made by said sample and hold circuit represents an input signal quantity averaged of a time period of less than one tenth of 1/f, where f is the greatest frequency of interest in said input signal.

5. The apparatus of claim 1 wherein said measurement made by said sample and hold circuit represents an input signal quantity averaged over a time period less than 10 picoseconds.

6. The apparatus of claim 1 wherein said plurality of times form a sequence having a Fourier transform that is substantially constant as a function of frequency.

7. The apparatus of claim 1 wherein said plurality of time are chosen randomly or pseudo-randomly within said sampling time period.

8. The apparatus of claim 1 wherein said data processor statistically analyzes said received measurements to provide a measurement of an input signal property.

9. The apparatus of claim 1 wherein said input signal property is related to the maximum power generated by said input signal in a load during said sampling time period.

10. The apparatus of claim 8 wherein said data processor fits a measured statistical distribution to a predetermined function to provide said measurement of said input signal property.

11. The apparatus of claim 10 wherein said data processor determines a maximum power value by extrapolating said measured statistical distribution.
